(19) United States
(12) Patent Application Publication
(10) Pub. No.: US 2018/0026770 A1
(43) Pub. Date: Jan. 25, 2018

(54) Method, System and Device for Providing Uplink Control Information

(71) Applicant: Telefonaktiebolaget LM Ericsson (publ), Stockholm (SE)

(72) Inventors: Shaohua Li, Beijing (CN); Jinhua Liu, Beijing (CN); Xinghua Song, Beijing (CN)

(21) Appl. No.: 15/547,124

(22) PCT Filed: Jan. 30, 2015
(86) PCT No.: PCT/CN2015/071995

§ 371 Date: Jul. 28, 2017

(51) Int. Cl. H04L 5/00; H04L 1/18

(52) U.S. Cl. CPC H04L 5/0055; H04L 1/1812; H04W 84/042

(57) ABSTRACT

A method, system and device for providing Information elements regarding aggregated carriers in an LTE or LTE advanced telecommunication system. The method enables application of a defined Information channel, such as the Physical Uplink Control Channel, PUCCH, previously defined as limited in the number of information elements PUCCH may comprise, into an alternative wherein the limitation is lifted. The encoding of the information elements is applied according to either jointly encoded or segmenting and interleaved encoded, the selection of the encoding scheme depending on the number of information elements and the number of specific information elements the selected PUCCH format may comprise.

### TECHNICAL FIELD

The present invention relates generally to a method, system and device to enable a User Equipment to inform a Radio Base Station entity on carrier related qualifiers in a mobile network.

### BACKGROUND

In a typical cellular network, also referred to as a wireless communication system, a User Equipment, UE, communicates via a Radio Access Network, RAN to one or more Core Networks, CNs.

A UE is referred to as a mobile terminal by which a subscriber can access services offered by an operator's CN. The UEs may be for example communication devices such as mobile telephones, cellular telephones, laptops, tablet computers or vehicle-mounted mobile devices, enabled to communicate voice and/or data. The wireless capability enables to communicate voice and/or data, via the RAN, with another entity, such as another UE or a server.

The cellular network covers a geographical area which is divided into cell based areas. Each cell area is served by a Base Station, BS, or Radio Base Station, RBS, which is also referred to as e.g. “evolved NodeB”, “eNB”, “eNodeB”, “NodeB”, “B node”, or Base Transceiver Station, BTS, depending on the technology and terminology used.

The RBSs may be of different classes such as e.g. macro RBS, home RBS or pico RBS, based on transmission power and thereby also on cell size.

A cell is the geographical area where radio coverage is provided by the RBS at a RBS site. One RBS may serve one or more cells, also denoted as carriers. Further, each RBS may support one or several communication technologies. The RBSs communicate over the air interface operating on radio frequencies with the UEs within coverage range of the RBSs.

The Universal Mobile Telecommunication System, UMTS, is a third-generation, 3G, mobile communication system, which evolved from the second-generation, 2G, Global System for Mobile communications, GSM, and is intended to provide improved mobile communication services based on Wideband Code Division Multiple Access, W-CDMA access technology. UMTS Terrestrial Radio Access Network, UTRAN is essentially a RAN using W-CDMA. The 3rd. Generation Partnership Project, 3GPP, has undertaken to evolve further the UTRAN (and GSM) based radio access network technologies.

The Long Term Evolution, LTE, and LTE-advanced mobile communication system is defined as the fourth-generation mobile communication technology standard within the 3GPP as to improve the UMTS to cope with future requirements in terms of improved services such as higher data rates, improved efficiency, and lower costs. The UTRAN, being the radio access network of UMTS is further developed into an Evolved UTRAN, E-UTRAN, also referred to as a mobile broadband network, and indicated as the radio access network of an LTE (advanced) system. In an E-UTRAN, a UE is wirelessly connected to a RBS, commonly referred to as evolved NodeB, eNodeB or eNB.

FIG. 1 illustrates a block diagram of a telecommunication system 100 with an E-UTRAN comprising a RBS 110, having two cells, serving UE 150 located within the RBS's geographical area of service, presented as a first cell 110A, and a second cell 110B. FIG. 1 illustrates only one RBS as an example. In practice a RBS is surrounded by—and connected to multiple RBSs.

The RAN of FIG. 1 additionally shows a neighboring RBS entity 120, denoted as a Remote Radio Head, RRH, e.g. an access point for a Local Area Network, LAN, also capable to serve UE 150 as its cell 120A geographically covers a service area for UE 150.

Both the RBS 110 and the RRH 120 are linked via links 112 and 122 respectively to each other and other entities comprised by network 140 as to enable cooperation.

The CN in an E-UTRAN system comprises a Mobility Management Entity, MME, which is the main signaling node in the EPC. The MME is responsible for initiating paging and authentication of the UE.

A RAN 100, such as an E-UTRAN, is often deployed on multiple carrier frequencies. A carrier frequency is the center frequency used for the radio communication between the RBS and the UE. Carrier frequencies are usually organized in radio frequency bands, the carrier frequencies bandwidth typically ranging from 5 to 20 MHz depending on the allocation of the Radio Frequency (RF), although future expansion may be expected.

A RBS may provide a number of radio cells on each carrier frequency, overlaid, overlaying or overlapping with each other or sectorized and pointing in different directions from the RBS.

Different cells and different carrier frequencies may offer system capacity that varies within a wide range. The cell configuration, the presence of radio interference, time-dispersion effects and the distribution of UEs within the cell affecting so called near-far-relations, are examples of factors influencing the system capacity.

The use of LTE Carrier Aggregation, CA, introduced in LTE Release-10 and enhanced in LTE Release-11, offers means to increase the peak data rates, system capacity and user experience by simultaneously aggregating radio resources from multiple carriers that may reside in the same band or different bands. CA can be used in LTE for both Frequency Division Duplex, FDD, signaling and Time Division Duplex, TDD, signaling. The aggregated carriers are also referred as Component Carriers, CC.

In LTE Release-13, LAA, Licensed Assisted Access, is proposed to be a candidate for further extending the LTE carrier aggregation feature towards capturing the spectrum opportunities of unlicensed spectrum in the 5 GHz band, such as applying the RRH 120 with its cell 120A. E.g. state of the art Wireless Local Area Networks (WLAN) operating in the 5 GHz band already supports 80 MHz and further extensions are to be expected, such as with the IEEE 802.11 ac standard. Aggregation of more than one carrier on the same band is an option, in addition to the bands already in use for LTE.

Enabling the utilization of at least similar bandwidths for LTE in combination with LAA, such as IEEE 802.11ac, provides extended throughput capabilities for the LTE advanced system.

Compared to single-carrier operation, a UE operating with CA has to report feedback for more than one Down Link, DL component carriers. A channel to support reporting feedback of the DL is called the Physical Uplink Control Channel, PUCCH.

Regarding PUCCH, several formats have been defined by IEEE. In LTE Release-8, PUCCH formats 1/1a/1b and PUCCH formats 2/2a/2b are defined, supporting Scheduling Requests, SR, Hybrid Automatic Report Requests acknowledge/not-acknowledge, HARQ-Ack/NAck, and periodic Channel State Information, CSI reporting.

The PUCCH resource is represented by a single scalar resource index, from which the phase rotation and the orthogonal cover sequence (only for PUCCH format 1/1a/1b) are derived. The use of a phase rotation of a cell-specific sequence together with orthogonal sequences provides orthogonallity between different UEs in the same cell transmitting PUCCH on the same set of resource blocks.

In LTE Release-10, PUCCH format 3 was introduced for supporting carrier aggregation and Time Division Duplex, TDD, mode when there are multiple downlink transmissions, (either on multiple carriers or multiple downlink sub-frames) but single uplink (either single carrier or single uplink sub-frame) for HARQ-Ack/NAck, SR and CSI feedback. Similarly, the PUCCH format 3 resource is also represented by a single scalar index from which the orthogonal sequence and the resource-block number can be derived. A length-5 orthogonal sequence is applied for PUCCH format 3 to support code multiplexing within one resource-block pair and a length-4 orthogonal sequence is applied for shorted PUCCH.

The remainder of this section, when referring to PUCCH, will apply to PUCCH format 3. LTE (advanced) has been defined to apply a frame lasting 10 ms and each frame comprising 10 sub-frames wherein each sub-frame comprises two slots of each 0.5 ms. A slot forms PRBs with each 7 symbols, resulting into 84 Resource Elements as there are twelve sub-carriers. PUCCH resources are defined by a code and two PRBs (or scheduling blocks) consecutive in time with hopping at the slot boundary. The PUCCH resource is determined according to higher layer configuration and a dynamic indication from the downlink assignment.

In LTE Releases-10, 11 and 12, the maximum downlink component carriers are defined as five. For each downlink applying aggregated (or component) carriers, at most 2 Ack/Nack bits are needed for each FDD component carrier, and 4 Ack/Nack bits are needed for each TDD component carrier (except for TDD configuration 5). In total, there are 5*4=20 bits for Ack/Nack feedback. In LTE Releases 10, 11 and 12, the PUCCH has a capacity of 21 or 22 bits, depending on the FDD or TDD use respectively. The capacity of the PUCCH suffices to provide CSI feedback for five aggregated carriers.

However, in future LTE releases it is expected that the number of aggregated carriers available for a single UE will increase. If the same feedback bits are needed for FDD and TDD, the maximum Ack/Nack feedback bits would be 32*4=128 bits if e.g. the number of aggregated carriers would be 32. Then PUCCH capacity will not be sufficient, resulting in a limitation of the control channel capacity, as each UE has only a single PUCCH.

### SUMMARY

In view of the discussion above, it is an object for embodiments herein to provide a solution that the full frequency diversity can be achieved based on an improved Physical Uplink Control Channel, PUCCH, encoding. It is another object that the improved PUCCH format is flexible and easy to adapt to a changed Down Link, DL, configuration with respect to the number of aggregated carriers.

In an aspect of the invention a method for providing feedback elements, regarding carrier signal information is proposed between a Radio Base Station, RBS, and a User Equipment, UE, in a wireless telecommunication network, via a dedicated channel, wherein more than one carrier is applied between the RBS and the UE. The method proposes a number of steps;
Determining a number of the feedback elements, M;
Determining a number of units of the dedicated channel, N;
Selecting an encoding scheme based on the values of M and N, and
Encoding the feedback elements according to the selected encoding scheme into the units of the dedicated channel.

In a further aspect the proposed method the provision of the feedback elements is performed by the UE towards the RBS.

In a still further aspect of the invention the method proposes that the feedback elements are bits representing Hybrid Automatic Repeat Requests Acknowledge/non-Acknowledge (HARQ-Ack/NAck) in a Long Term Evolution (LTE) or LTE-advanced technology.

In a still further aspect of the invention the method proposes that the determining step of the number of units of the dedicated channel is M divided by the maximum number of HARQ-Ack/NAcks that one unit of the dedicated channel can comprise or the optimum number of HARQ-ack/Nacks that one unit of the dedicated channel can comprise.

In a still further aspect of the invention the method proposes that the dedicated channel is a Physical Uplink Control Channel, PUCCH, and the units of the dedicated channel are Physical Resource Blocks, PRBs, in a Long Term Evolution (LTE) or LTE advanced technology.

In a still further aspect of the invention the method proposes that at the selecting step a first encoding scheme is selected when M divided by 48 times N is lower than ½, and that a second encoding scheme is selected when M divided by 48 times N is equal or higher than ½.

In a still further aspect of the invention the method proposes that the encoding according to the first encoding scheme is performed by jointly encoding the feedback elements and that the encoding according to the second encoding scheme is performed by segmenting, interleaving and multiplexing the feedback elements.

In a still further aspect of the invention it is proposed that the method applies mapping of the encoded feedback elements to physical resources of the Physical Uplink Control Channel, PUCCH, in a Long Term Evolution (LTE) or LTE advanced technology.

The invention proposes a method in a User Equipment, UE, for providing feedback elements, regarding carrier signal information, between a Radio Base Station, RBS, UE, in a wireless telecommunication network, via a dedicated channel, wherein more than one carrier is applied between the RBS and the UE. The method in the UE applies the steps of;
Determining a number of the feedback elements, M;
Determining a number of units of the dedicated channel, N;
Selecting an encoding scheme based on the values of M and N, and
Encoding (208, 210) the feedback elements according to the selected encoding scheme into the units of the dedicated channel.

In a further aspect of the method in the UE proposes that a first encoding scheme is selected when M divided by 48 times N is lower than ½, and a second encoding scheme (210) is selected when M divided by 48 times N is equal or higher than ½.

In a still further aspect of the method in the UE proposes that the encoding according to the first encoding scheme is performed by jointly encoding the feedback elements. Additionally the method in the UE proposes that the encoding according to the second encoding scheme is performed by segmenting, interleaving and multiplexing the feedback elements.

In a further aspect of the method in the UE the method proposes that the dedicated channel is a Physical Uplink Control Channel, PUCCH, and the units of the dedicated channel are Physical Resource Blocks, PRBs, in a Long Term Evolution (LTE) or LTE advanced technology.

In an aspect of the invention a method in a Radio Base Station, RBS, is proposed for receiving feedback elements, regarding carrier signal information, between the RBS, and a User Equipment, UE, in a wireless telecommunication network, via a dedicated channel, wherein more than one carrier is applied between the RBS and the UE. The method in the RBS proposes that the number of slots comprising the feedback elements in the dedicated channel, that is composed by the UE, amounts more than two slots.

In an aspect of the invention a system is proposed, wherein the system is a wireless telecommunication network, for providing feedback elements, regarding carrier signal information, between a Radio Base Station, RBS, and a User Equipment, UE, both comprised by the wireless telecommunication network. The feedback elements are provided via a dedicated channel, and between the UE and RBS more than one carrier is applied. The system is arranged to have the UE perform the steps of:
Determining a number of the feedback elements, M;
Determining a number of units of the dedicated channel, N;
Selecting an encoding scheme based on the values of M and N, and
Encoding the feedback elements according to the selected encoding scheme into the units of the dedicated channel.

In an aspect of the invention a device, being a User Equipment, UE, device is proposed for use in a cellular communication network system, wherein the UE arranged for providing feedback elements, regarding carrier signal information, between a Radio Base Station, RBS, and the UE, both comprised by the wireless telecommunication network, and wherein the feedback elements are provided via a dedicated channel. The network system applies more than one carrier between the RBS and the UE.

The UE device comprises;
a first determiner for determination of a number of the feedback elements, “M”;
a second determiner for determination of a number of units of the dedicated channel, “N”, and
a encoding scheme selector, that is arranged to perform a selection of a first- or a second encoding scheme to be applied based on the values of M and N.

In a further aspect of the UE device the UE further comprises;
A first encoder for encoding the feedback elements according to the first encoding scheme that applies jointly encoding of the feedback elements, and
A second encoder for encoding the feedback elements according to the second encoding scheme that applies segmenting, interleaving and multiplexing of the feedback elements.

In a still further aspect of the UE device, the UE is arranged to operate in an application or a combination of an LTE, an LTE-advanced, or a LAN network such as a Wi-Fi IEEE 802n or 802ac technology based network, the UE supporting Aggregated carriers.

In an aspect of the invention a computer program is proposed, which, when being executed by a processor in a User Equipment, UE, is adapted to carry out or control a method for providing feedback elements, regarding carrier signal information, between a Radio Base Station, RBS, and the UE in a wireless telecommunication network. The feedback elements are provided via a dedicated channel. In the telecommunication system there is more than one carrier applied between the RBS and the UE. The computer program is arranged to execute the steps of:
Determining a number of the feedback elements, M;
Determining a number of units of the dedicated channel, N;
Selecting an encoding scheme based on the values of M and N, and
Encoding the feedback elements according to the selected encoding scheme into the units of the dedicated channel.

In an aspect of the invention a User Equipment, UE, is proposed wherein the UE provides feedback elements, regarding carrier signal information, between a Radio Base Station, RBS, and the UE, in a wireless telecommunication network, via a dedicated channel, wherein more than one carrier is applied between the RBS and the UE. The UE comprises;
a first determination module for determining a number of the feedback elements, “M”;
a second determination module for determining a number of units of the dedicated channel, “N”, and
a selector module for selecting a first or second encoding scheme based on the values of M and N.

The UE additionally comprises;
a first encoder module for encoding the feedback elements according to the first encoding scheme into the units of the dedicated channel, and
a second encoder module for encoding the feedback elements according to the second encoding scheme into the units of the dedicated channel.

These and other embodiments according to the present invention are now illustrated in more detail with reference to the enclosed drawings.

### BRIEF DESCRIPTION OF THE DRAWINGS

FIG. 1 is a block diagram illustrating an embodiment of a system;

FIG. 2 is a flowchart illustrating an embodiment of method steps;

FIG. 3 is a block diagram illustrating an embodiment of a method steps;

FIG. 4 is a block diagram illustrating an embodiment of a method steps;

FIG. 5 is a block diagram illustrating an embodiment of a device.

### DETAILED DESCRIPTION

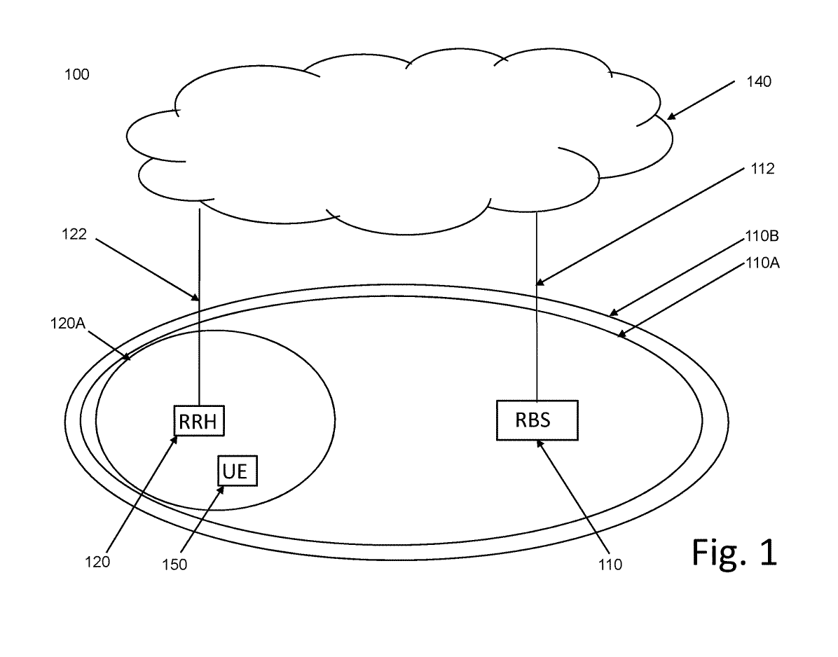

With reference to FIG. 1, the explanation of the method of providing Uplink Control Information, UCI, in a cellular communications system is presented in the implementation of an Evolved-Universal Mobile Telecommunication, UMTS, Terrestrial Radio Access Network, E-UTRAN, system.

In this explanation a reference to a Long Term Evolution, LTE, network may be equated with the E-UTRAN system, and a Radio Base Station, RBS, may be equated with an evolved NodeB, eNodeB, as applied in the LTE or LTE-advanced network.

The explanation equates a carrier frequency with a physical cell as a way to ease the explanation. Although cells 110A, 110B and 120A as shown in FIG. 1 can be implemented as substantially overlapping concentric circles, having more than one carrier frequency, any form of the cell coverage such as sectored beams may also be applied in particular for overlapping areas, representing two or more cells.

Carrier aggregation, CA, for the case of inter-band Time Division Duplex, TDD, CA, may be configured with different Up-Link/Down-Link, UL/DL, configurations. In LTE Release 12, carrier aggregation between TDD and Frequency Division Duplex, FDD, serving cells is introduced to support User Equipment, UE connecting to them simultaneously.

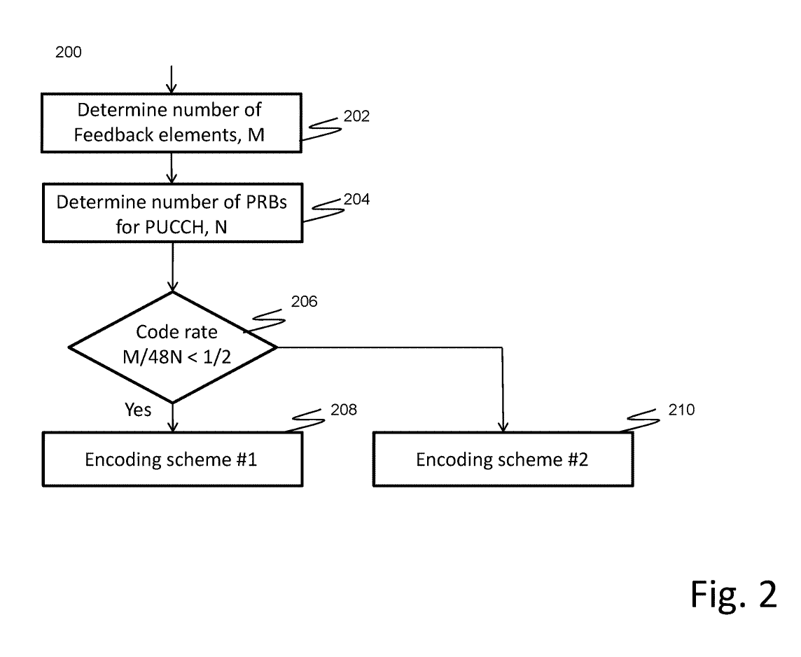

FIG. 2 is a flowchart 200 illustrating an embodiment of method steps wherein the encoding of the PUCCH is established.

At step 202, the number of feedback elements is determined. The number of feedback elements may comprise any qualifier of e.g. a Scheduling Request, SR, Hybrid Automatic Report Requests Acknowledge/Not-Acknowledge, HARQ-Ack/NAck, Channel State Information/Channel Quality Indicator, CSI/CQI, Multiple Input Multiple Output, MIMO, feedback, Rank Indicator, RI, or Pre-coding Matrix Indicator, PMI, for each single Down-Link, DL, carrier.

For the ease of the explanation the focus will be set on the feedback elements relating to HARQ-Ack/NAck information via the PUCCH, although any other of the mentioned qualifiers may apply. As a practical implementation the feedback elements are defined as bits, and denoted with the identifier “M”.

At step 204, the number of Physical Resource Blocks, PRBs, to be applied in the PUCCH, is determined for the PUCCH according to the number of downlink component, or aggregated, carriers and the component carrier configuration(s). the number of PRBs is denoted with the identifier “N”.

As an example, focussing on the feedback of HARQ-Ack/NAck bits, N can be determined as:

N=M/K

Wherein K is the maximum number of HARQ-Ack/NAck bits that can be carried on a single PUCCH resource. E.g. 21 bits on a PUCCH Format 3 resource in Time Division Duplex, TDD, mode.

At step 206 a selection of an encoding scheme to be applied on the feedback elements, is made. The selection is based on the values of M and N, defined in previous steps 202 and 204 respectively.

As example selection criteria, it is proposed to apply a first encoding scheme 208, wherein the information bits are jointly encoded, when the code rate:

M/48*N<½

A second, different encoding scheme 210 will be applied when the code rate:

M/48*N>=½

According to selection step 206, different N (nbr. of PRBs for PUCCH) yields different coding schemes. According to this example, in case the code rate [M/48*N] is less than ½, one encoding block is used, and the maximum frequency diversity can be achieved. In case the code rate is larger than ½, one encoding block cannot achieve the maximum frequency diversity. If two coding blocks are used, the maximum frequency diversity can be achieved. Hence, two encoding schemes based on the coding rate are proposed. With the segmentation into two different encoding schemes depending on M and N, the encoding can achieve maximum frequency diversity.

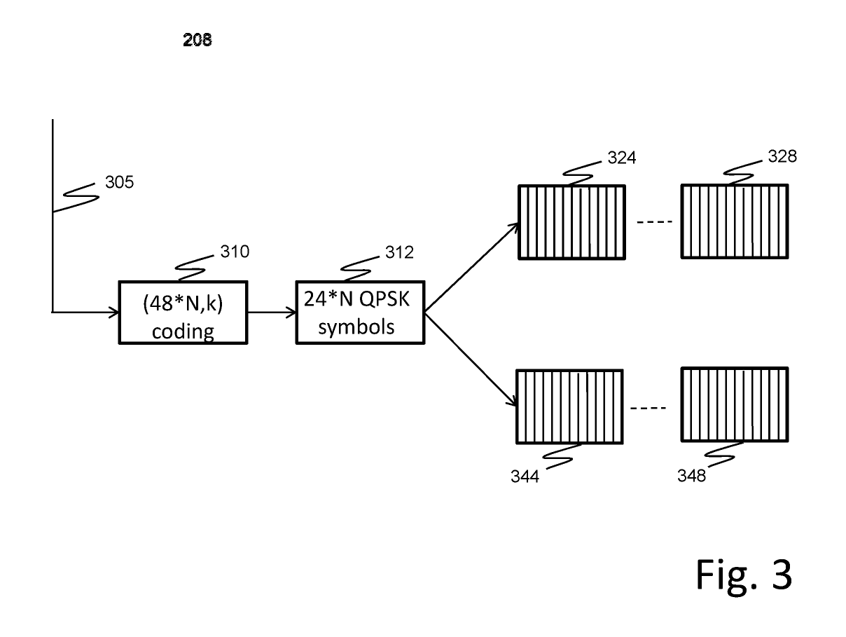

FIG. 3: In the first type encoding scheme 208, the information elements are jointly encoded. The feedback elements to be encoded are received 305 and fed to a coding entity 310. Focussing on bits, such as HARQ-Ack/NAck bits, the coding entity 310 is arranged to provide chunks of 48 coded bits.

The feedback elements are in this embodiment proposed as HARQ-Ack/NAck bits, although the encoding applies to any other feedback element in relation to the DL carriers.

The PUCCH format 3 resource is determined according to higher layer configuration and a dynamic indication from the DL assignment.

It is proposed to apply Reed-Muller, RM, coding when M=K.

This RM coding by encoder entity 310 results into 48 coded bits. Subsequently the 48 bits will then be modulated by modulator 312 into 24 Quadrature Phase Shift Keying, QPSK, symbols, these symbols are mapped onto the required slots, slot 0, PRB_0, 324, until slot 0, PRB_(N−1), 328 and slot 1, PRB_0, 344, until slot 1, PRB_(N−1), 348. The number of slots 324, 328, 344 and 348 is not a static defined feature, but depending on the values of N and M which may be dynamic.

When M>K, the value of 1 being a predefined adjustable threshold, other error control coding may be used. One example is to use convolution coding. In another example, it is to use turbo coding.

Assuming the feedback elements such as UCI information bits are {a₀, a₁, . . . a_{M-1}}, the output bits of the encoder 310 constitute a sequence of {b₀, b₁, . . . b_{B-1}}, resulting from the function f₁;

b₁=f₁(a₀,a₁, . . . a_{M-1},i),
wherein B=48*N and i=0, 1, 2, . . . B−1

The sequence of encoded bits {b₀, b₁, . . . b_{B-1}}, is scrambled with a UE-specific scrambling sequence. The block of scrambled bits shall be QPSK modulated by modulator 312 into 24*N complex-value symbols as Section 7.1 of 3GPP TS 36.211. The complex-value symbols shall be further block-wise spread with the orthogonal sequences. Each set of spread complex-valued symbols shall be cyclically shifted and be transformed pre-coded.

Having the symbols associated with the UCI modulated, the symbols mapped to the N PRBs are provided to the physical resources. The PRBs to be used for transmission of the PUCCH in slot nₛ are given by n_{PRB}, n_{PRB+1}, n_{PRB+(N-1)}, wherein m is given by higher layer signaling;

If (m+nₛ mod 2)mod 2=0, then n_{PRB}=m/2, and

If (m+nₛ mod 2)mod 2=1, then n_{PRB}=N−1−m/2

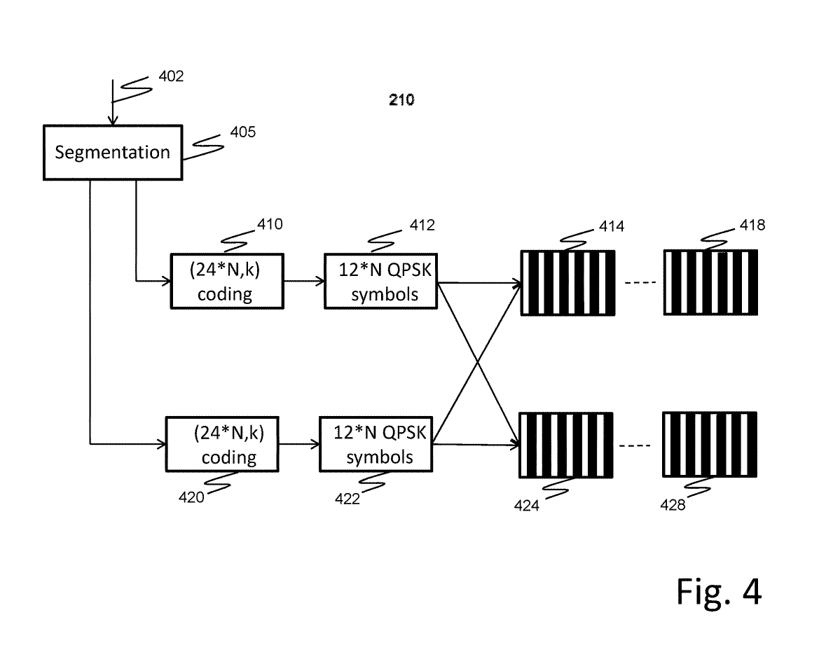

FIG. 4: In the second type encoding scheme 210, the information bits are segmented into two segments first. For each segment, one encoder is used. The two outputs of the segmentation will be interleaved and multiplexed together. With this segmentation into two different encoding schemes, the encoding can achieve maximum frequency diversity.

The feedback elements to be encoded are received 302 and divided into two segments by segmenting-unit 405, segmenting the received feedback elements each representing a part of the received 402 feedback elements.

Focussing on a first branch handling one segment from segmenting-unit 405, comprising entities 410, 412, 414 and 418, encoding entity 410 receives the feedback elements. Focussing on bits, such as HARQ-Ack/NAck bits, the coding entity 410 is arranged to provide chunks of 24 coded bits.

The feedback elements are in this embodiment proposed as HARQ-Ack/NAck bits, although the encoding applies to any other feedback element in relation to the carriers.

The PUCCH format 3 resource is determined according to higher layer configuration and a dynamic indication from the DL (or UL when UL-CA applied) assignment. It is proposed to apply Reed-Muller, RM, coding when M=K.

Subsequently the chunks of 24 bits will be modulated by modulator 412 into 12 Quadrature Phase Shift Keying, QPSK, symbols.

The second branch comprising entities 420, 422, 424 and 428, acting on the other segment of the divided feedback elements, are respectively performing the same function as 410, 412, 414 and 418 of the first branch.

These symbols modulated by modulator 412 are interleaved and mapped onto the required slots, slot 0, PRB_0, 414, until slot 0, PRB_(N−1), 418 and slot 1, PRB_0, 424, until slot 1, PRB_(N−1), 428. The interleaving is indicated FIG. 4 with black and white indications of the slots 414, 418, 424 and 428.

The number of slots 414, 418, 424 and 428 is not a static defined feature, but depending on the values of N and M, which may be dynamic.

When M>K, the value of K being a predefined adjustable threshold, other error control coding may be used. One example is to use convolution coding. In another example, it is to use turbo coding.
The sequence of bits for the first branch 410 . . .

$${a}_{0} , {a}_{1} , … , {a}_{⌈ \frac{M}{2} ⌉ - 1}$$

and for the second branch 420 . . .

$${a}_{⌈ \frac{M}{2} ⌉} , {a}_{⌈ \frac{M}{2} ⌉ + 1} , … , {a}_{M - 1}$$

are encoded as follows;
for the first branch 410 . . .

$${\tilde{b}}_{i} = {f}_{2} ( {a}_{0} , {a}_{1} , … , {a}_{⌈ \frac{M}{2} ⌉ + 1} , i )$$

for the second branch 420 . . .

$${\tilde{\tilde{b}}}_{i} = {f}_{2} ( {a}_{⌈ \frac{M}{2} ⌉} , {a}_{⌈ \frac{M}{2} ⌉ + 1} , … , {a}_{M - 1} , i )$$

wherein B=48*N and i=0, 1, 2, . . . [B/2]−1
The output bit sequence b₀, b₁, b₂, . . . , b_{B-1} is obtained by the alternate concatenation of the bit sequence \tilde{b}₀, \tilde{b}₁, \tilde{b}₂, . . . , \tilde{b}_{B/2-1} and \tilde{\tilde{b}}₀, \tilde{\tilde{b}}₁, \tilde{\tilde{b}}₂, . . . , \tilde{\tilde{b}}_{B/2-1} as follows:

```
Set i,j = 0
while i < 48N
  bᵢ = \tilde{b}ⱼ, bᵢ₊₁ = \tilde{b}ⱼ₊₁
  bᵢ₊₂ = [symbol]    ⱼ, bᵢ₊₃ = [symbol]    ⱼ₊₁
  i = i + 4
  j = j + 2
end while
```

The sequence of encoded bits {b₀, b₁, . . . d_{B-1}}, is scrambled with a UE-specific scrambling sequence. The block of scrambled bits shall be QPSK modulated by modulators 412 and 422 into 12*N complex-value symbols as Section 7.1 of 3GPP TS 36.211. These two sets of 12 QPSK symbols will be interleaved and mapped into slots 414, 418, 424 and 428 with block-wise spreading with the orthogonal sequences. Each set of spread complex-valued symbols is cyclically shifted and be transformed pre-coded.

Having the symbols associated with the UCI modulated, the symbols mapped to the N PRBs are provided to the physical resources. The PRBs to be used for transmission of the PUCCH in slot nₛ are given by n_{PRB}, n_{PRB+1}, n_{PRB+(N-1)}, wherein m is given by higher layer signaling;

If (m+nₛ mod 2)mod 2=0, then n_{PRB}=m/2, and

If (m+nₛ mod 2)mod 2=1, then n_{PRB}=N−1−m/2

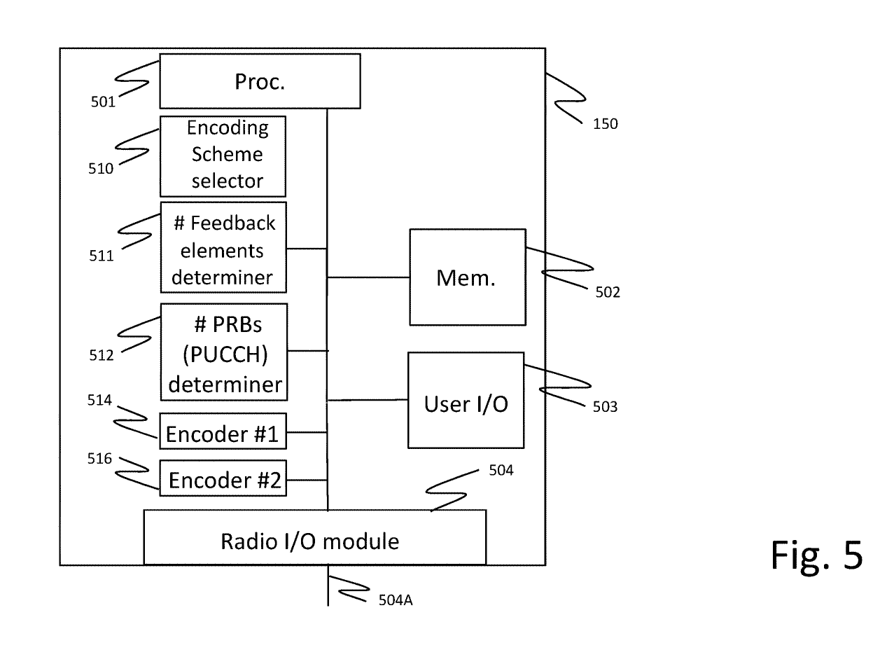

FIG. 5 is a block diagram illustrating an embodiment of the UE 150 arranged for providing feedback elements such as UCI information according the method illustrated above.

The UE 150 comprises:
a processor module 501 arranged to process program instructions;
a memory module 502 arranged to store the program instructions and network parameters;
a radio interface module 504 arranged to connect to wireless network entities, such as the RBS 110 or RRH 120 by means of antenna 504A;
a user interface, Input/Output, I/O, 503 comprising multiple functions representing at least a display, a keyboard, a microphone and a speaker;
a first determiner entity 511 arranged for determination of a number of the feedback elements, “M”;
a second determiner entity 512 arranged to determine the number of PRBs based on the number of feedback elements to be provided and the maximum number of feedback elements of a specific type of a dedicated channel to provide the feedback elements, the determined number of PRBs denoted as “N”;
an encoding scheme selector 510, arranged to perform a selection of the a first or a second encoding scheme to be applied based on the values of M and N;
a first encoder 514 arranged to perform the first encoding scheme 208;
a second encoder 516 arranged to perform the first encoding scheme 210,

The processor module 701 is further arranged, under the program instructions, to control the radio interface module 504, the user I/O 503, the selector, 510, the definer 512, the first encoder 514 and the second encoder 516.

The UE is arranged to operate in any combination of an LTE, an LTE-advanced, and a LAN network such a Wi-Fi IEEE 802n or 802ac technology based network.

The UE 150 is in arranged to determine the number of feedback elements M to be provided to a network entity, such as a RBS 110, when applying simultaneously multiple carriers.

The invention offers the advantage by selecting one of two different encoding schemes, the frequency diversity can be achieved for the proposed way of encoding of the dedicated feedback channel, in this case for LTE and LTE-advanced being the PUCCH resource.

With the proposed encoding scheme, the PUCCH format is flexible and it is easy to adapt to different Downlink configuration with respect to the number of aggregated carriers.

1-23. (canceled)

24. A method for providing feedback elements, regarding carrier signal information, between a Radio Base Station (RBS) and a User Equipment (UE) in a wireless telecommunication network, via a dedicated channel, wherein more than one carrier is applied between the RBS and the UE, the method comprising:
determining a number of the feedback elements, M;
determining a number of units of the dedicated channel, N;
selecting an encoding scheme based on the values of M and N; and
encoding the feedback elements according to the selected encoding scheme into the units of the dedicated channel.

25. The method according to claim 24, wherein the providing of feedback elements is performed by the UE towards the RBS.

26. The method according to claim 24, wherein the feedback elements are bits representing Hybrid Automatic Repeat Requests Acknowledge/non-Acknowledge (HARQ-Ack/NAck) in a Long Term Evolution (LTE) or LTE-advanced technology.

27. The method according to claim 26, wherein the number of units of the dedicated channel is M divided by the maximum number of HARQ-Ack/NAcks that one unit of the dedicated channel can comprise or the optimum number of HARQ-Ack/NAcks that one unit of the dedicated channel can comprise.

28. The method according to claim 24, wherein the dedicated channel is a Physical Uplink Control Channel (PUCCH), and the units of the dedicated channel are Physical Resource Blocks (PRBs) in a Long Term Evolution (LTE) or LTE-advanced technology.

29. The method according to claim 24, wherein at the selecting step, a first encoding scheme is selected when M divided by 48*N is lower than ½, and a second encoding scheme is selected when M divided by 48*N is equal or higher than ½.

30. The method according to claim 29, wherein the encoding according to the first encoding scheme is performed by jointly encoding the feedback elements.

31. The method according to claim 30, wherein the encoded feedback elements are mapped to physical resources of the Physical Uplink Control Channel (PUCCH) in a Long Term Evolution (LTE) or LTE advanced technology.

32. The method according to claim 30, wherein the encoding is further decided based on the value of M, and wherein a first type of coding is selected when M is less than a first threshold, and a second type of coding is selected when M is equal or larger than the first threshold.

33. The method according to claim 29, wherein the encoding according to the second encoding scheme is performed by segmenting, interleaving and multiplexing the feedback elements.

34. The method according to claim 33, wherein the encoding is further decided based on the values of M, wherein a first type of coding is selected when M is less than a second threshold, and a second type of coding is selected when M is equal or larger than the second threshold.

35. The method according to claim 34, wherein the first type of coding is Reed-Muller code, and the second type of coding is convolution code or turbo code.

36. A method in a User Equipment (UE) for providing feedback elements, regarding carrier signal information, between a Radio Base Station (RBS) and the User Equipment (UE) in a wireless telecommunication network, via a dedicated channel, wherein more than one carrier is applied between the RBS and the UE, the method comprising:
determining a number of the feedback elements, M;
determining a number of units of the dedicated channel, N;
selecting an encoding scheme based on the values of M and N; and
encoding the feedback elements according to the selected encoding scheme into the units of the dedicated channel.

37. The method according to claim 36, wherein at the selecting step a first encoding scheme is selected when M divided by 48*N is lower than ½, and a second encoding scheme is selected when M divided by 48*N is equal or higher than ½.

38. The method according to claim 37, wherein the encoding according to the first encoding scheme is performed by jointly encoding the feedback elements and the encoding according to the second encoding scheme is performed by segmenting, interleaving and multiplexing the feedback elements.

39. The method according to claim 36, wherein the dedicated channel is a Physical Uplink Control Channel (PUCCH), and the units of the dedicated channel are Physical Resource Blocks (PRBs) in a Long Term Evolution (LTE) or LTE-advanced technology.

40. A method in a Radio Base Station (RBS) for receiving feedback elements, regarding carrier signal information, between the Radio Base Station (RBS) and a User Equipment (UE) in a wireless telecommunication network, via a dedicated channel, wherein more than one carrier is applied between the RBS and the UE, and wherein the number of slots comprising feedback elements in the dedicated channel, composed by the UE, is more than two slots.

41. A User Equipment (UE) configured for use in a cellular communication network system, the UE arranged for providing feedback elements, regarding carrier signal information, between a Radio Base Station (RBS) and the UE comprised by the wireless telecommunication network, via a dedicated channel, wherein more than one carrier is applied between the RBS and the UE, and wherein the UE comprises processing circuitry configured to:
determine a number of the feedback elements, M;
determine a number of units of the dedicated channel, N;
select a first or a second encoding scheme to be applied for encoding the feedback elements, based on the values of M and N; and
encode the feedback elements according to the selected encoding scheme into the units of the dedicated channel.

42. The UE according to claim 41, wherein processing circuitry comprises:
a first encoder circuit configured to encode the feedback elements according to the first encoding scheme applying joint encoding of the feedback elements; and
a second encoder circuit configured to encode the feedback elements according to the second encoding scheme applying segmenting, interleaving and multiplexing the feedback elements.

43. The UE according to claim 41, wherein the UE is arranged to operate in an any one or more of a Long Term Evolution (LTE) network, an LTE-advanced network, or a Local Access Network (LAN) network, and where the UE is configured to support aggregated carriers.

44. A non-transitory computer-readable medium storing a computer program comprising program instructions that, when executed by processor circuitry in a User Equipment (UE), configures the UE to provide feedback elements, regarding carrier signal information, between a Radio Base Station (RBS) and the UE in a wireless telecommunication network, via a dedicated channel, wherein more than one carrier is applied between the RBS and the UE, said computer program comprising program instructions to configure the UE to:
determine a number of the feedback elements, M;
determine a number of units of the dedicated channel, N;
select an encoding scheme based on the values of M and N; and
encode the feedback elements according to the selected encoding scheme into the units of the dedicated channel.
